(19) United States
(12) Patent Application Publication
(10) Pub. No.: US 2022/0063117 A1
(43) Pub. Date: Mar. 3, 2022

(54) Hair Cutting System and Methods of Use

(71) Applicant: Moses BROWN, San Diego, CA (US)

(72) Inventor: Moses BROWN, San Diego, CA (US)

(21) Appl. No.: 17/445,943

(22) Filed: Aug. 25, 2021

Related U.S. Application Data
(60) Provisional application No. 63/070,198, filed on Aug. 25, 2020.

(51) Int. Cl. B26B 19/38; B26B 19/20

(52) U.S. Cl. CPC B26B 19/388; G06F 3/14; B26B 19/205

(57) ABSTRACT

Various embodiments of a system for cutting hair are described herein. The hair cutting system includes a user interface, a positioning mechanism, a securing mechanism, and a cutting mechanism. The power source is configured to supply electrical power while the user interface includes a data receiving unit for receiving data related to a head of a user, and a display is configured to input data and/or display data. The cutting mechanism is electrically coupled to the power source for cutting the hair on the head of the user. The positioning mechanism is for positioning the cutting mechanism relative to the head of the user, and the securing mechanism for supporting the positioning mechanism. Related apparatus and methods are also described.

### CROSS-REFERENCES TO RELATED APPLICATIONS

This application claims priority to and the benefit of U.S. Provisional Patent Application Ser. No. 63/070,198 filed on Aug. 25, 2020, entitled “Hair Cutting Device and Methods of Use” which is incorporated by reference in its entirety for all purposes.

### TECHNICAL FIELD

The subject matter described herein relates to systems and apparatuses for cutting hair, and methods of use thereof.

### BACKGROUND

Standard hair cutters or clippers rely on a separate person, such as a hair stylist or barber, to manually measure the length of a subject's hair and cut the subject's hair into the desired style, based on the hair stylist's individual skill set and ability to interpret the subject's instructions regarding their desired hair length and style. Additionally, contemporary fashion changes rapidly, and haircuts and/or hair styles can become increasingly complex. As such, it would be desirable to utilize a hair cutting means that is capable of producing a variety of haircuts and/or styles of varying detail and complexity. Additionally, it would be advantageous to provide a hair cutting system that can provide a haircut or style that provides a user with feedback to ensure that the haircut and/or style is precisely aligned with the user's preferences. Provided herein are solutions to these and other issues in the art.

### SUMMARY

In an aspect, a hair cutting system is provided. The hair cutting system includes a power source, a user interface including a data receiving unit and a display, a securing mechanism, a positioning mechanism, and a cutting mechanism.

In an aspect, a hair cutting system includes a power source configured to supply electrical power. The hair cutting system also includes a user interface with a data receiving unit for receiving data related to a head of a user, and a display configured to input data and/or display data. The hair cutting system also includes a cutting mechanism electrically coupled to the power source for cutting the hair on the head of the user and a positioning mechanism for positioning the cutting mechanism relative to the head of the user. The hair cutting system also includes a securing mechanism for supporting the positioning mechanism.

The power source can include one or more of an electrochemical battery, a power pack specific to the hair cutting system, a rechargeable component, or a charging cable. The power source can also include a connection to AC power. The power source can be electrically coupled to the user interface, and/or the positioning mechanism.

The user interface can include a touchscreen, a keyboard, or a computer. The data related to the head of the user can include a three-dimensional representation of the head, information about a hair type, and/or information about hair length.

The cutting mechanism can include one or more blades. The one or more blades can be serrated. The cutting mechanism can include clippers. The cutting mechanism can include a plurality of blades that are adjustable to cut a curved surface. The cutting mechanism can include a plurality of blades that are adjustable to move upwards or downwards relative to each other.

The positioning mechanism can include a mechanical arm, a rail system, and/or a gear system. The positioning mechanism can include a linear actuator to advance and retract the cutting mechanism in an outer casing. The positioning mechanism can include electrical actuator or pneumatic actuator to advance and retract the cutting mechanism in an outer casing.

The securing mechanism can include a handle for the user to grasp, a base for attachment to a chair, a base for attachment to a frame, and/or a base for attachment to a wall, a floor, or a ceiling. The cutting mechanism, the securing mechanism, and/or the positioning mechanism can be disposable.

The hair cutting system can further include a head position detection system for generating data related to the head of the user. The head position detection system can emit a detectable signal to triangulate a position of the head, the detectable signal including one or more of a wireless signal, a radio signal, or an acoustic signal. The head position detection system can include ultrasonic transmitters and receivers to generate a three-dimensional mapping of the head of the user. The head position detection system can include a plurality of cameras to generate a three-dimensional mapping of the head of the user. The head position detection system can include a laser scanner to generate a three-dimensional mapping of the head of the user. The head position detection system can include a tracking pen to generate a three-dimensional mapping of the head of the user. The head position detection system can include a mold for mapping the head of the user.

The hair cutting system can further include a hair positioning system for positioning the hair on the head of the user prior to cutting. The hair positioning system can include a one-way guard or a static guard that is configured to accept the hair only when the hair is in a certain direction or position. The hair positioning system can include a flat plate can be used to push the hair up into a cutting position. The hair positioning system includes a suction device used to pull the hair into a cavity such that the cutting mechanism can cut the hair to a specified length. The hair positioning system can include two plates to position hair within a pinch point and into contact with the cutting mechanism. The hair positioning system can include an air current source that is used to push the hair against the grain of the hair to allow the hair cutting system to accurately cut the hair. The hair positioning system includes a static electricity source to position the hair radially outward from the head prior to cutting.

In another, interrelated aspect, a method of cutting hair is provided. The method includes receiving data relating to a head into a hair cutting system. The method further includes confirming the data relating to the head, receiving instructions relating to cutting the hair, confirming the instructions with a user, securing a support mechanism to the head, dynamically positioning and repositioning the hair cutting system in relation to the hair and the head to cut the hair based on the instructions relating to cutting the hair; and collecting loose hair.

In an aspect, a method of cutting hair includes receiving data relating to a head of a user into a hair cutting system. The hair cutting system includes a power source configured to supply electrical power, and a user interface with a data receiving unit and a display. The hair cutting system also includes a cutting mechanism electrically coupled to the power source for cutting the hair on the head of the use, a positioning mechanism for positioning the cutting mechanism relative to the head of the user and a securing mechanism for supporting the positioning mechanism. The method of cutting hair includes confirming the data relating to the head of the user, receiving instructions relating to cutting the hair on the head of the user, confirming the instructions with the user, securing a support mechanism; and dynamically positioning and repositioning the hair cutting system in relation to the hair and the head to cut the hair based on the instructions relating to cutting the hair.

The method of cutting hair can further include collecting loose hair.

The power source used in the methods can include one or more of an electrochemical battery, a power pack specific to the hair cutting system, a rechargeable component, or a charging cable. The power source can also include a connection to AC power. The power source can be electrically coupled to the user interface, and/or the positioning mechanism.

The user interface used in the methods can include a touchscreen, a keyboard, or a computer. The data related to the head of the user can include a three-dimensional representation of the head, information about a hair type, and/or information about hair length.

The cutting mechanism used in the methods can include one or more blades. The one or more blades can be serrated. The cutting mechanism can include clippers. The cutting mechanism can include a plurality of blades that are adjustable to cut a curved surface. The cutting mechanism can include a plurality of blades that are adjustable to move upwards or downwards relative to each other.

The positioning mechanism used in the methods can include a mechanical arm, a rail system, and/or a gear system. The positioning mechanism can include a linear actuator to advance and retract the cutting mechanism in an outer casing. The positioning mechanism can include electrical actuator or pneumatic actuator to advance and retract the cutting mechanism in an outer casing.

The securing mechanism used in the methods can include a handle for the user to grasp, a base for attachment to a chair, a base for attachment to a frame, and/or a base for attachment to a wall, a floor, or a ceiling. The cutting mechanism, the securing mechanism, and/or the positioning mechanism can be disposable.

The method can further include generating data related to the head of the user with a head position detection system. The head position detection system can emit a detectable signal to triangulate a position of the head, the detectable signal including one or more of a wireless signal, a radio signal, or an acoustic signal. The head position detection system can include ultrasonic transmitters and receivers to generate a three-dimensional mapping of the head of the user. The head position detection system can include a plurality of cameras to generate a three-dimensional mapping of the head of the user. The head position detection system can include a laser scanner to generate a three-dimensional mapping of the head of the user. The head position detection system can include a tracking pen to generate a three-dimensional mapping of the head of the user. The head position detection system can include a mold for mapping the head of the user.

The method can further include positioning the hair on the head of the user prior to cutting using a hair positioning system. The hair positioning system can include a one-way guard or a static guard that is configured to accept the hair only when the hair is in a certain direction or position. The hair positioning system can include a flat plate can be used to push the hair up into a cutting position. The hair positioning system includes a suction device used to pull the hair into a cavity such that the cutting mechanism can cut the hair to a specified length. The hair positioning system can include two plates to position hair within a pinch point and into contact with the cutting mechanism. The hair positioning system can include an air current source that is used to push the hair against the grain of the hair to allow the hair cutting system to accurately cut the hair. The hair positioning system includes a static electricity source to position the hair radially outward from the head prior to cutting.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

FIG. 1 is an example spherical coordinate system for use with a hair cutting system and method as described herein.

FIG. 2 is an example diagram of a plane tangent to a sphere and associated coordinate system for use with a hair cutting system and method as described herein.

FIG. 3 is a flow chart outlining a method of cutting hair as described herein.

FIGS. 4A-4F show various implementations of the Input Head Data step of the flow chart of FIG. 3.

FIGS. 5A-5F show various implementations of the Position Hair step of the flow chart of FIG. 3.

FIGS. 6A-6E show various implementations of the Position Cutting Mechanism step of the flow chart of FIG. 3.

FIGS. 7A-7E show various implementations of the Detect Cutting Mechanism step of the flow chart of FIG. 3.

FIGS. 8A-8B show various implementations of the Adjust Cutting Mechanism Position/Orientation (Radial) step of the flow chart of FIG. 3.

FIGS. 9A-9B show various implementations of the Apply Cutting Force step of the flow chart of FIG. 3.

FIGS. 10A-10G show various implementations of the cutting mechanism and positioning mechanisms.

### DETAILED DESCRIPTION

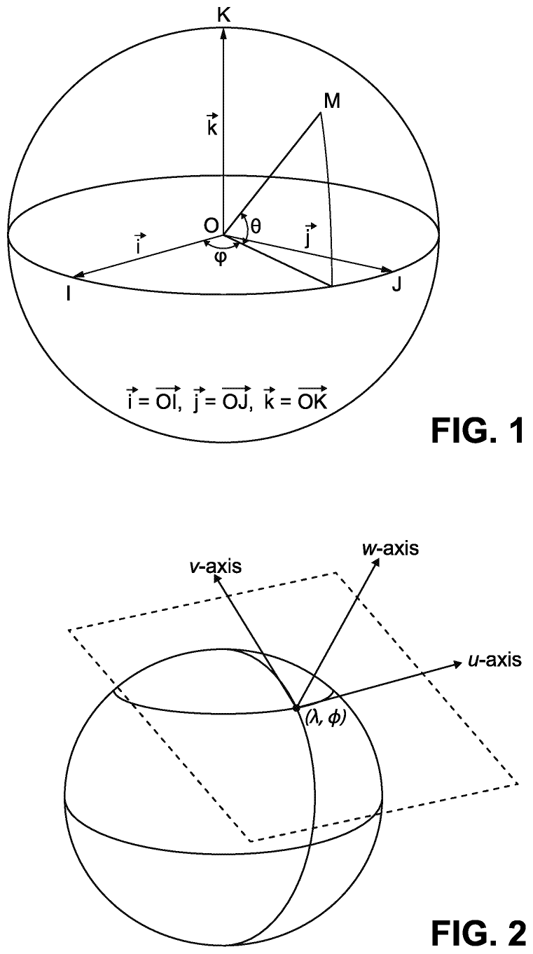

The present disclosure relates to a hair cutting system and a method of cutting hair. The hair cutting system can include a power source, a user interface including a data receiving unit and a display, a securing mechanism, a positioning mechanism, and a cutting mechanism. The method can include receiving data relating to a head into a hair cutting system. The method can further include confirming the data relating to the head, receiving instructions relating to cutting the hair, confirming the instructions with a user, securing a support mechanism to the head, dynamically positioning and repositioning the hair cutting system in relation to the hair and the head to cut the hair based on the instructions relating to cutting the hair; and collecting loose hair. The hair cutting system and method of cutting hair are configured to use a coordinate system to map a user's head. For example, the coordinate system can be based on the system shown in FIG. 1.

In the coordinate system shown in FIG. 1, 0 represents “theta,” y represents “phi,” and the line OM represents “radial distance.” Any point in space can be described by increasing or decreasing the angle of phi and/or theta, and/or the radial distance. All positioning of the hair cutting system relative to the user's head can be described using phi, theta, and radial distance. Angular changes refer to the orientation of the hair cutting system relative to the user's head. For example, if the cutting mechanism of the hair cutting system is a clipper blade or blades, the blade(s) are always tangential to the user's head, as shown in FIG. 2.

FIG. 2 shows a plane tangent to a sphere. Shown are three axes, the u-axis and v-axis, which are perpendicular to one another, and the w-axis which extends outwardly from the plane defined by the u-axis and v-axis. In embodiments, the cutting mechanism can be pivoted by changing the angle between the w-axis and either the v-axis or the u-axis.

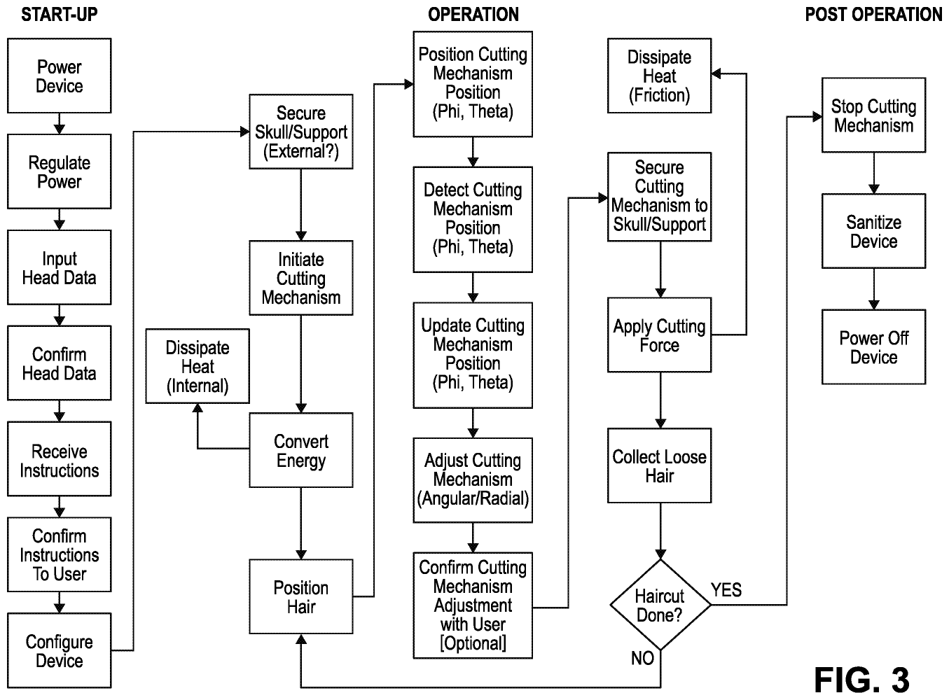

FIG. 3 is a flow chart illustrating the various steps of the hair cutting method provided herein. As shown, the method can be roughly divided into three processes: start-up, operation, and post-operation. During start-up, the hair cutting system is powered on, and data relating to the user's head is input and confirmed by the user or by another party. Additionally, instructions relating to the desired hair cut style are received and confirmed, and the hair cutting system can then be configured to cut the hair to the desired length and/or style. During operation, a support mechanism can be attached to the user's head, and the cutting mechanism can be initiated. During cutting, energy is converted and internal heat is dissipated. The hair can then be positioned according to the desired cutting pattern. Additionally and/or alternatively, the cutting mechanism can be positioned according to the desired phi and/or theta angles input by the user or by another party. The cutting mechanism position, in terms of phi and/or theta angles, can then be detected and updated, and adjusted in terms of angular and/or radial distance. Optionally, the cutting mechanism adjustments can be confirmed with the user before proceeding to the cutting steps. The cutting mechanism can then be secured to the support mechanism, or directly to the user's head, and cutting force can be applied, such as to create the desired hair length and/or style. Finally, loose hair can be collected. During post-operation (i.e. once the desired hair length and/or style has been achieved) the cutting mechanism is stopped, and the hair cutting system can be sanitized and powered off.

The hair cutting system can be powered by any suitable means. In embodiments, the hair cutting system can be powered by electrochemical batteries. For example, rechargeable lithium ion or nickel cadmium batteries which are widely commercially available can be used in the hair cutting system. In some embodiments, a power pack or other powering component that is specific to the hair cutting system can be used. In some embodiments, a cord or cable can be used to plug the hair cutting system, or a rechargeable component of the hair cutting system, into a power source such as a wall outlet providing AC electrical power. For example, a rechargeable battery unit or other rechargeable component can be plugged in to a power source such as an outlet and can charge the hair cutting system continuously, such that the hair cutting system can be used wirelessly when it is sufficiently charged. Once powered on, the power to the hair cutting system can be regulated using internal circuits and resistors. For example, if an internal circuit is used, a series of wires and/or other electrical components can regulate voltage and current to the desired level. Additionally and/or alternatively, a series of resistors can transform electricity into heat.

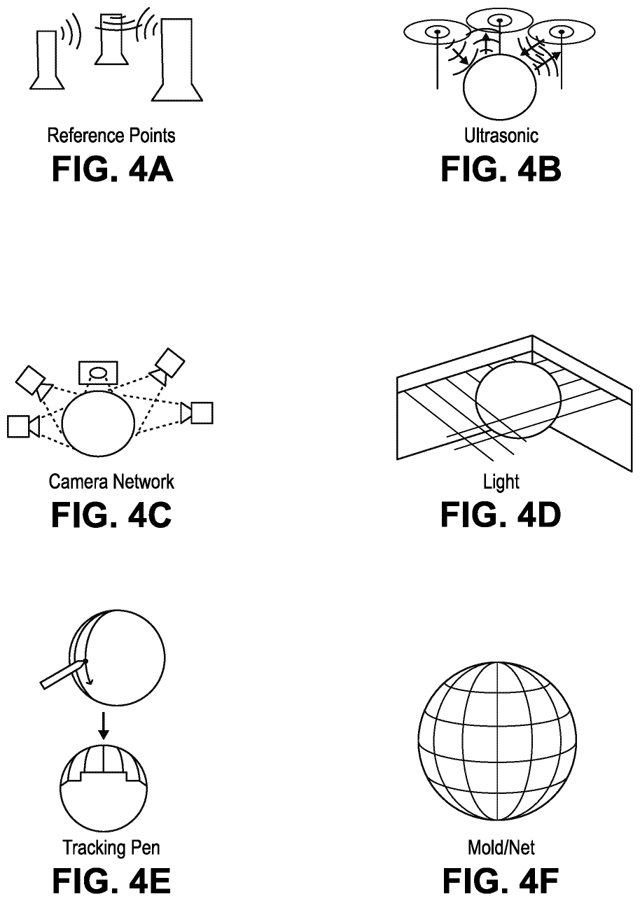

When inputting data relating to the user's head, any suitable method of detecting head position can be used. The methods used to input head data are similar to those used to detect the cutting mechanism position. FIGS. 4A-4F illustrate various embodiments of head position detection methods.

As shown in FIG. 4A, in some embodiments, separate reference points which emit a detectable signal may be used to triangulate the position of the head. For example, the reference points can emit wireless signals, radio signals, acoustic signals, or any signal suitable to locate head position. Static reference points can be configured to determine where the head is in relation to the reference points. FIG. 4B illustrates an embodiment of head position detection, which uses ultrasonic vibrations, such as ultrasound or ultrasonography, to detect head position. For example, fixed towers that emit a constant ultrasonic signal can use reflection strength or lack thereof to determine head position and shape. FIG. 4C illustrates an embodiment of head position detection using a plurality of cameras, which can be connected to form a network, to visualize the position of the user's head. For example, photographs can be taken of the head and stitched together to form a three-dimensional image of the head. FIG. 4D illustrates an embodiment of head position detection using light waves to detect the user's head position. For example, scanning light waves can be used to stitch multiple flat planes together to form an image, similar to magnetic resonance imaging (MRI). As shown in FIG. 4E, in some embodiments a tracking pen or other tracing method can be used to detect the position of the user's head. For example, the user or another party can trace the surface of the head with a specialized pen or drawing tool while a computer or other processor tracks the movement of the pen or drawing tool and interpolates the movement into a rough head shape. An example of a tracking pen is the FASTRAK DIGITIZER available from Polhemus, Colchester, Vt. In some embodiments, such as that shown in FIG. 4F, a mold or net can be used to detect the user's head position.

In conjunction with any of the head data input or confirmation methods shown in FIGS. 4A-4F and described herein, an application-based method can be used to configure a device, such as a mobile phone or other computing device, to communicate with the hair cutting system and thereby input head data. In some embodiments, the application can support multiple different user profiles. In addition to head shape and position data, hair type data can also be set. For example, hair type can be set via questionnaires or selection lists, by detection equipment such as that shown in FIGS. 4A-4F or the like, or by using artificial intelligence or machine learning to analyze photographs or other visualizations to determine hair type.

The head and/or hair data obtained can be confirmed with the user or another party. For example, a display unit integrated on or attached to the hair cutting system can show the user or other party a preview of the head shape, for review and/or confirmation. In some embodiments, an application associated with a personal computing device, such as a mobile phone, can be used to show a preview of the head and/or hair data. The hair cutting system can receive instructions via any suitable input method or device. In some embodiments, a touchpad can be used to receive instructions. For example, the user or another party can enter instructions via a digital interface or other user interface. Additionally and/or alternatively, a microphone can be used to convert sound waves emitted by the user or other party into digital information to be processed by a computing device. Additionally and/or alternatively, a keyboard or other button- or key-based system can be used, allowing the user or other party to input a series of keystrokes or a button pressing pattern to provide instructions to the hair cutting system. In some embodiments, the hair cutting system can connect to an application, such as a mobile device application, via Bluetooth, Wi-Fi, radio, or other wireless signal to receive instructions wirelessly from the application.

During the final steps of the start-up portion of the hair cutting method, the hair cutting system confirms the instructions received and configures the hair cutting system accordingly. The instructions received from the user or other party can be confirmed via any suitable method such as a preview, a list, or a speaker. For example, a preview can be provided to the user or other party for review and confirmation. In some embodiments, a list of options to be selected can be displayed to the user or other party for selection. In other embodiments, a speaker or other audio device can be used to sound out a list of options to be selected. Once the instructions have been confirmed, the hair cutting system can be configured. In some embodiments, a system of gears can be used to move the components of the hair cutting system into the desired orientation. Additionally and/or alternatively, a computer chip or other processing chip can be used to store instructions and control logic for each new haircut or style input into the hair cutting system.

During the operation stages of the hair cutting method provided herein, the cutting mechanism is initiated. The cutting mechanism initiation can be achieved via a button, switch, voice-activated mechanism, distance sensor, or the like. For example, the user or another party can press a button or activate a mechanical switch to initiate the cutting mechanism. Alternatively, a sensor, such as a voice-activated sensor or a distance sensor, can be used to trigger cutting mechanism initiation. For example, a distance sensor can be configured such that, when the cutting mechanism is within a defined radial distance from the head, the cutting mechanism is initiated. During operation of the hair cutting system, energy is converted and heat is dissipated. For example, a motor can be used to convert electrical energy to mechanical rotational motion, or a laser generator can be used to convert electricity to focused light energy. Internal heat can be dissipated within the hair cutting system via a heat sink, a natural convection system, a forced convection system, or the like. For example, a conductive material can be positioned within the hair cutting system and configured to draw heat into the conductive material and transport the heat away from the hair cutting system via convection, into the ambient air around the hair cutting system. In other embodiments, ambient air can be allowed to flow naturally through the hair cutting system such as to dissipate internal heat via convection, or a stream of fluid or air can be forced through the hair cutting system to dissipate the heat via forced convection.

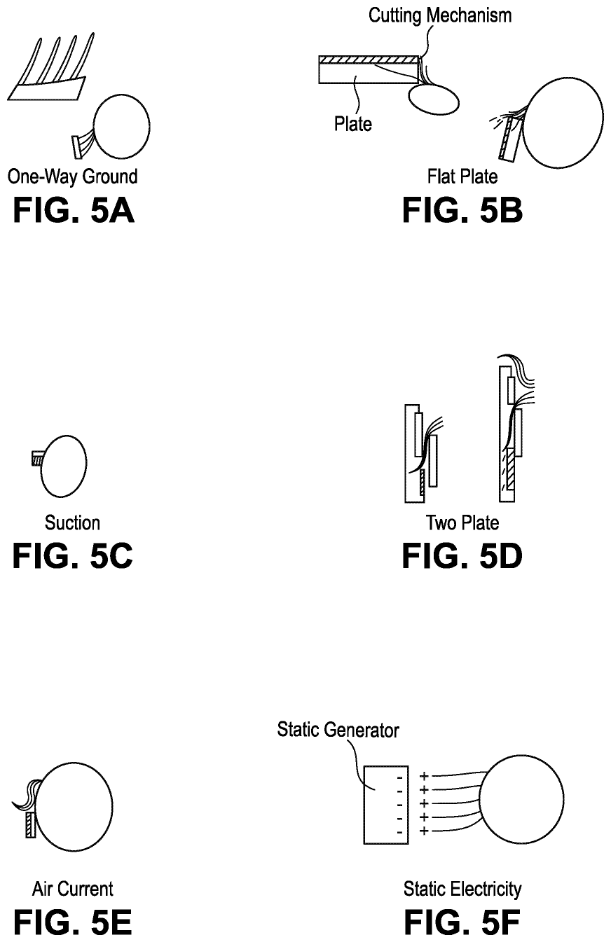

FIGS. 5A-5F illustrate various embodiments of hair positioning methods. As shown in FIG. 5A, a one-way guard or static guard that is configured to accept hair only when the hair is in a certain direction or position can be used to position the hair. In some embodiments, such as that shown in FIG. 5B, a flat plate can be used to push the hair up into a cutting position. For example, the flat plate can be a continuous plate that is without teeth or grooves. As shown in FIG. 5C, suction can be used to pull hair into a cavity such that the cutting mechanism can cut the hair to a specified length defined by the dimensions of the cavity. As shown in FIG. 5D, two plates can be used to position hair within a pinch point and into contact with the cutting mechanism. For example, the two plates can be flat plates or the two plates can have teeth or grooves. FIG. 5E shows an embodiment in which an air current source that is used to push the hair against the grain of the hair, thus allowing the hair cutting system to accurately cut the hair. For example, the air current could be mono-, bi-, or multi-directional, and a combination of pushing and pulling force could be used, such as to provide a more precise and predictable position for the hair. In some embodiments, such as that shown in FIG. 5F, static electricity could be used. For example, attractive static electric force could be used to position the hair radially outward from the head.

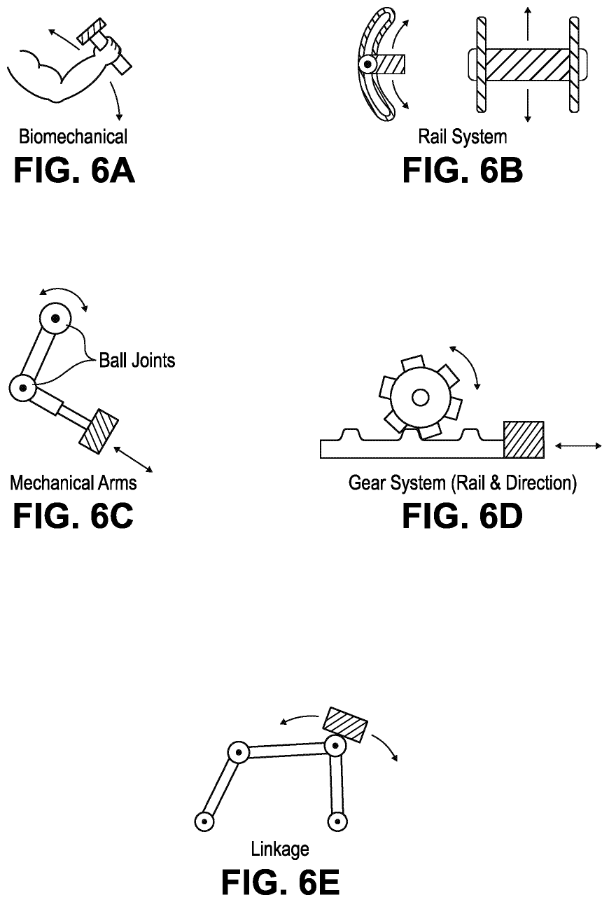

The radial position of the cutting mechanism can be adjusted using phi and theta angles, to position the cutting mechanism. FIGS. 6A-6E illustrate various embodiments of cutting mechanism positioning methods. As shown in FIG. 6A, biomechanical movement can be used to position the cutting mechanism (i.e. the user or other party physically moves the cutting system). In other embodiments, such as that shown in FIG. 6B, an automated rail system can be used to position the cutting mechanism, by sliding the cutting mechanism over the rails of the automated rail system. As shown in FIG. 6C, mechanical arms attached to swiveling mechanisms, such as ball joints, can be used to position the cutting mechanism. As shown in FIG. 6D, a gear system can be used to position the cutting mechanism, similarly to the rail system described previously, but using gears such as intertwined gears, rather than rails. In other embodiments, such as that shown in FIG. 6E, a linkage system connecting together multiple linkages can be used to allow motion of the cutting mechanism only within a defined range.

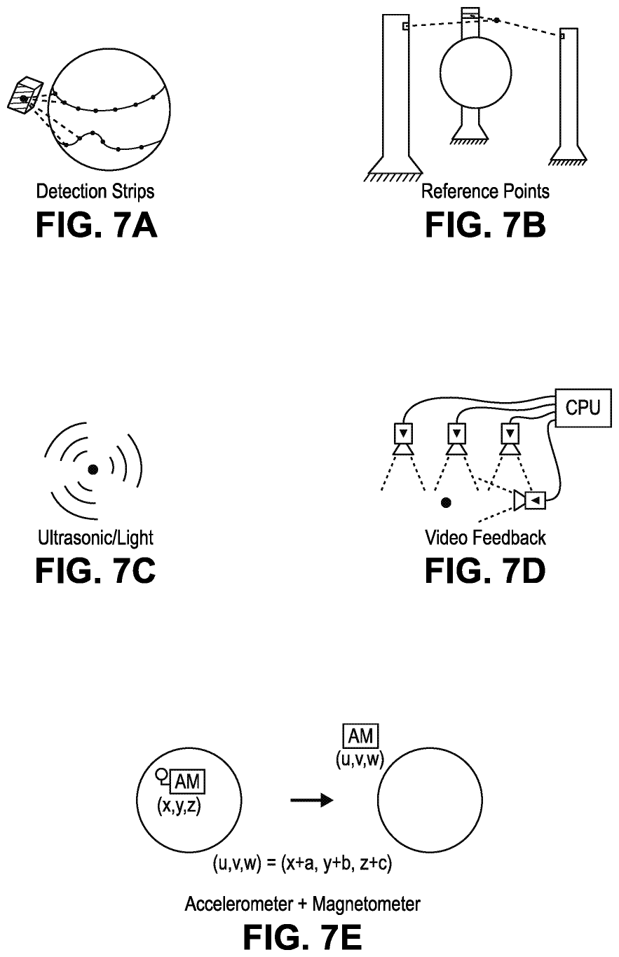

Once the cutting mechanism has been positioned, the position of the cutting mechanism can be detected continuously, in real-time, according to its phi and theta angles. FIGS. 7A-7E illustrate various embodiments of cutting mechanism position detection methods. As shown in FIG. 7A, detection strips can be placed along the head and configured to sense the phi and theta positioning of the cutting mechanism. As shown in FIG. 7B, static reference points can be used to determine the position of the cutting mechanism relative to the static reference points. In some embodiments, as shown in FIG. 7C, ultrasonic sound or light waves can be used to detect the cutting mechanism position. For example, the cutting mechanism can emit a continuous ultrasonic sound, or can use a small light, and can use reflection strength to determine the position of the cutting mechanism. As shown in FIG. 7D, a camera network can be used to provide video or other visual feedback to track the position of the cutting mechanism. In other embodiments, such as that shown in FIG. 7E, a three-dimensional accelerometer can be used to track the force applied to the cutting mechanism, and a magnetometer can subtract the force of gravity, to thus determine the position of the cutting mechanism. The position of the cutting mechanism can be updated as the cutting mechanism moves along the head using a computer or other computing device, such as a mobile phone. For example, the computer or computing device can receive a signal from the cutting mechanism and process the signal to update and report the position of the cutting mechanism.

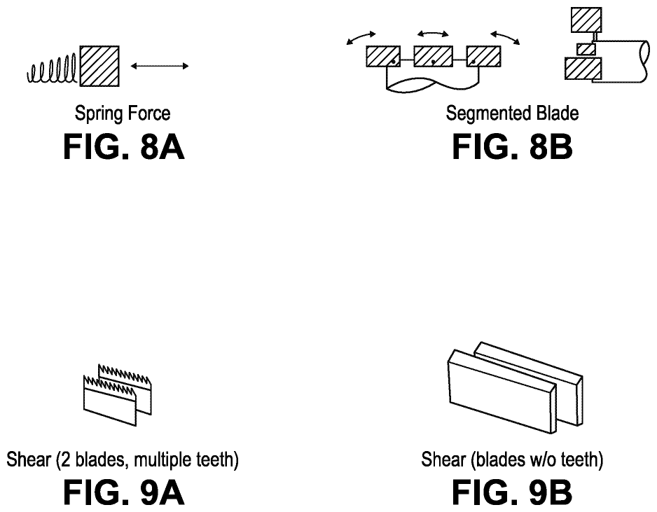

FIGS. 8A-8B illustrate embodiments of a method for adjusting the radial position/orientation of the cutting mechanism. As shown in FIG. 8A, a spring can be used to apply spring force and thus push the cutting mechanism into its lowest position, defined as the position in which the cutting mechanism is closest to the user's head. For example, when in its lowest position, the cutting mechanism may be touching or almost touching the user's head. Additional force can be applied by the user or another party to pull the cutting mechanism back, i.e. retract the cutting mechanism into the hair cutting system by moving the cutting mechanism in a direction away from the user's head and toward the hair cutting system, as needed to achieve the desired hair cut length. As shown in FIG. 8B, a segmented blade can be used, such that each segment of the blade has independent rotation and radial freedom in relation to the other segments. In some embodiments, not shown in the figures, a rail system having manual (i.e. static) or dynamically shaped rails configured to guide the cutting mechanism is used. In other embodiments, a gear system can be used. For example, gears can retract and extend the cutting mechanism within a housing, the housing configured to remain in constant contact with the head regardless of the position of the cutting mechanism.

Once positioned, the adjustment of the cutting mechanism can optionally be confirmed with the user or other party. In some embodiments, a real time display, such as a digital display, can update constantly, in real-time, to show the position of the cutting mechanism in relation to the head. In other embodiments, a digital counter can be used to show how far the cutting mechanism has progressed through a predetermined number set using digital numbers.

The cutting mechanism housing can then be secured to the head. For example, a static portion of the hair cutting system can be moved or pushed such that the static portion makes contact with the head with normal force. Cutting force can then be applied, sufficient to cut the hair to the desired length or style. FIGS. 9A-9B illustrate embodiments of cutting force application methods. As shown in FIG. 9A, shear force can be applied using two or more blades, each of the two or more blades having a plurality of teeth or similar protrusions. As shown in FIG. 9B, shear force can be applied using one or more single blades, each of the one or more single blades having no teeth or other protrusions. In some embodiments, not shown in the figures, a bright beam of light such as a laser can be used to precisely singe the hair. Once cut, loose hair can be collected via one or more suitable methods. For example, loose hair can be sucked into a vacuum chamber, attracted to a source of static electricity, pushed into a chamber using an air current other than a vacuum, can be allowed to fall to floor and retrieved later, or the like.

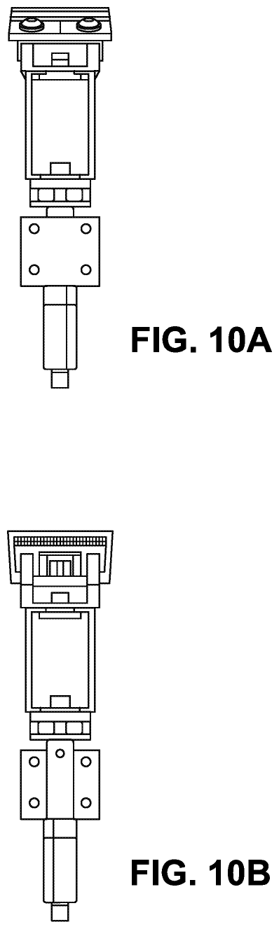

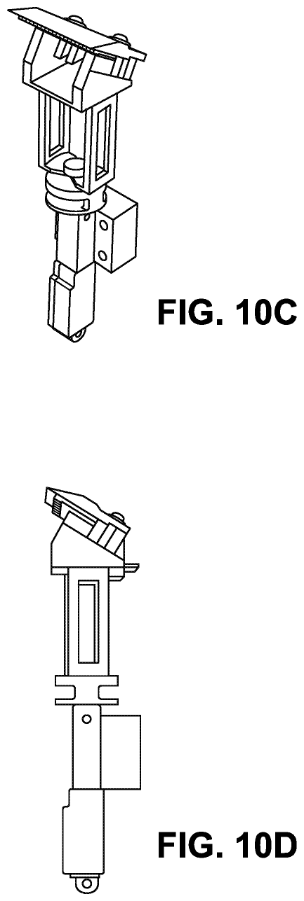

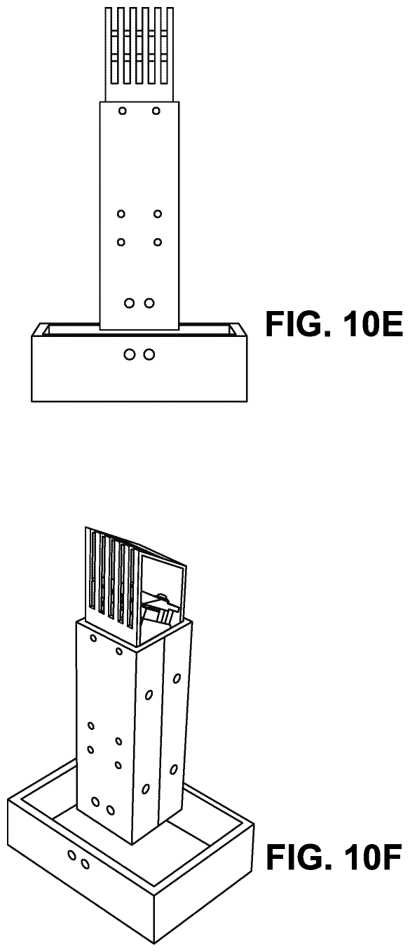

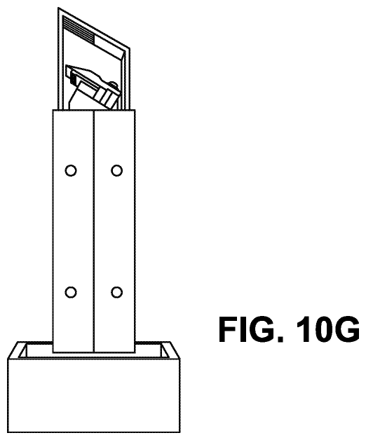

FIGS. 10A-10G show various implementations of the cutting mechanism and positioning mechanisms. In FIG. 10A, the back side view of an exemplary cutting mechanism is shown with the cutting portion located at the top of the figure. In FIG. 10B, the front side view of an exemplary cutting mechanism is shown with the cutting portion located at the top of the figure. In FIG. 10C, an isometric view of an exemplary cutting mechanism is shown with the cutting portion located at the top of the figure. In FIG. 10D, a left view of an exemplary cutting mechanism is shown with the cutting portion located at the top of the figure. As shown in FIG. 10E, the cutting mechanism has been inserted inside a portion of the positioning mechanism including an outer casing. The outer casing acts as a guard and spacer to position the cutting mechanism away from the head of a user. A liner actuator can be affixed between the cutting mechanism and positioning mechanism to advance and retract the cutting mechanism toward and away from the guard at the end of the outer casing. In FIG. 10F, an isometric view of an exemplary cutting mechanism is shown inserted inside a portion of the positioning mechanism including an outer casing. In FIG. 10G, a left view of an exemplary cutting mechanism is shown inserted inside a portion of the positioning mechanism including an outer casing. In an alternative embodiment (not shown), the outer casing includes two guards widely spaced apart to expose the cutting mechanism to hair that would otherwise get caught in the guard illustrated in FIGS. 10E-10G.

During the post-operation stages of the hair cutting method, the hair cutting system can be stopped, sanitized, and powered off. The stopping methods and powering off options are substantially the same as the initializing and powering on options described previously, such that they will not be repeated here for brevity. The hair cutting system can be sanitized by the user, another party, or automatically sanitized after reach use. For example, a fluid dispensing system can be configured to automatically clean the hair cutting system when powered off. In other embodiments, the hair cutting system may be configured such that any portions of the hair cutting system which contact the head are disposable and replaceable, and can be replaced after each user.

Safety measures can be used to prevent the cutting mechanism, e.g. blades, from cutting the user. For example, when more than a pre-set amount of resistance to the cutting mechanism is encountered, the cutting mechanism can be programmed to automatically stop. Alternatively, the cutting mechanism can detect whether it is cutting a foreign object other than hair (e.g., fabric, skin, glasses, a hat, clothing, or the like). For example, the ranges of such resistance for cutting various hair types can be known, such that as soon as the cutting mechanism encounters a resistance to the cutting force that is beyond such a range, the mechanism, e.g. blades, can either automatically shut down, or the hair cutting system can seek confirmation to continue from the user, prior to continuing to cut. Alternatively still, lasers and/or lights can detect whether the object that is being cut is hair, and to detect whether something is a foreign object, for example, based on known characteristics of hair and how it reacts to light, such as its transparency, or by measuring the density of what is being cut, or measuring other characteristics of what is being cut).

The following may be used to help describe the terms used herein, but in no way is intended to limit the term beyond that which these terms and used and described herein. The term “blade” as used herein can refer to any flat or textured cutting edge. The blade or blades may be single edged or double edged. The blade or blades may be serrated. The blade or blades may be tapered toward a thin cutting edge.

In this disclosure, “comprises,” “comprising,” “containing” and “having” and the like can have the meaning ascribed to them in U.S. Patent law and can mean “includes,” “including,” and the like. “Consisting essentially of or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

Although various illustrative embodiments are described herein, any of a number of changes can be made to various embodiments without departing from the teachings herein. For example, the order in which various described method steps are performed may often be changed in alternative embodiments, and in other alternative embodiments, one or more method steps may be skipped altogether. Optional features of various device and system embodiments may be included in some embodiments and not in others. Therefore, the foregoing description is provided primarily for exemplary purposes and should not be interpreted to limit the scope of the claims.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Use of the term “based on,” herein and in the claims is intended to mean, “based at least in part on,” such that an unrecited feature or element is also permissible.

The subject matter described herein can be embodied in systems, apparatus, methods, and/or articles depending on the desired configuration. The embodiments set forth in the foregoing description do not represent all embodiments consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the embodiments described herein can be directed to various combinations and sub-combinations of the disclosed features and/or combinations and sub-combinations of several further features disclosed herein. In addition, the logic flows depicted in the accompanying figures and/or described herein do not necessarily require the particular order shown, or sequential order, to achieve desirable results. Other embodiments may be within the scope of the following claims.

### EXAMPLES

### Example 1: Hair Cutting Product

Pre-Operation Setup. The device will be powered up, in this example via batteries. The power is then regulated by an internal circuit to ensure the device does not overload. The head data is then input via tracking pen, and the user is asked to confirm if it is accurate. The user then specifies what hairstyle they would want via touchscreen. This information is processed via computer, the user is shown what the hairstyle will look like on their head, and they are asked to confirm. After confirmation, the device is configured via computer code.

Operation. When the user is ready, they will initiate the cutting mechanism (multi-tooth blades) by pushing a button. The energy needed to start the mechanism is obtained from a motor converting electricity to motion and heat. The heat generated from the motor is dissipated via a heat sink, which evenly conducts heat throughout the device so it can be convected away by the air. The user's hair is positioned using a current of air to push the hair outward. At the same time, the blades are positioned (phi, theta) around the user's head with the biomechanical force of the user's arm. Simultaneously, this position is detected via accelerometer and magnetometer and updated in the logic chip, and the blades' radial position is adjusted by pulling on a spring with less or more force. The hair is collected in a chamber to be disposed of later. This process is repeated until the haircut is finished.

Post-Operation. After the haircut is complete, the blades are stopped via button press, and the device is powered off. The device is then sanitized by removing the disposable parts of the device.

1. A hair cutting system comprising:
a power source configured to supply electrical power;
a user interface, comprising:
a data receiving unit for receiving data related to a head of a user, and
a display configured to input data and/or display data;
a cutting mechanism electrically coupled to the power source for cutting the hair on the head of the user;
a positioning mechanism for positioning the cutting mechanism relative to the head of the user; and
a securing mechanism for supporting the positioning mechanism.

2. The hair cutting system of claim 1, wherein the power source comprises one or more of an electrochemical battery, a power pack specific to the hair cutting system, a rechargeable component, or a charging cable.

3. The hair cutting system of claim 1, wherein the power source comprises a connection to AC power.

4. The hair cutting system of claim 1, wherein the power source is electrically coupled to the user interface.

5. The hair cutting system of claim 1, wherein the power source is electrically coupled to the positioning mechanism.

6. The hair cutting system of claim 1, wherein the user interface comprises a touchscreen.

7. The hair cutting system of claim 1, wherein the user interface comprises a keyboard.

8. The hair cutting system of claim 1, wherein the user interface comprises a computer.

9. The hair cutting system of claim 1, wherein the data related to the head of the user includes a three-dimensional representation of the head.

10. The hair cutting system of claim 1, wherein the data related to the head of the user includes information about a hair type.

11. The hair cutting system of claim 1, wherein the data related to the head of the user includes information about a hair length.

12. The hair cutting system of claim 1, wherein the cutting mechanism comprises one or more blades.

13. The hair cutting system of claim 1, wherein the cutting mechanism comprises one or more blades that are serrated.

14. The hair cutting system of claim 1, wherein the cutting mechanism comprises clippers.

15. The hair cutting system of claim 1, wherein the cutting mechanism comprises a plurality of blades that are adjustable to cut a curved surface.

16. The hair cutting system of claim 1, wherein the cutting mechanism comprises a plurality of blades that are adjustable to move upwards or downwards relative to each other.

17. The hair cutting system of claim 1, wherein the positioning mechanism comprises a mechanical arm.

18. The hair cutting system of claim 1, wherein the positioning mechanism comprises a rail system.

19. The hair cutting system of claim 1, wherein the positioning mechanism comprises a gear system.

20. The hair cutting system of claim 1, wherein the positioning mechanism comprises a linear actuator to advance and retract the cutting mechanism in an outer casing.

21.-81. (canceled)
